(19) United States
(12) Patent Application Publication
(10) Pub. No.: US 2017/0091919 A1
(43) Pub. Date: Mar. 30, 2017

(54) IMAGE REGISTRATION DEVICE, METHOD, AND PROGRAM

(71) Applicant: FUJIFILM Corporation, Tokyo (JP)

(72) Inventor: Takatoshi KARINO, Tokyo (JP)

(73) Assignee: FUJIFILM Corporation, Tokyo (JP)

(21) Appl. No.: 15/278,562

(22) Filed: Sep. 28, 2016

(30) Foreign Application Priority Data
Sep. 29, 2015 (JP) 2015-191097

(51) Int. Cl. G06T 7/00; G06K 9/62

(52) U.S. Cl. CPC G06T 7/003; G06T 7/0016; G06K 9/6201; G06T 2207/10081; G06T 2207/20224; G06T 2207/30012; G06T 2207/30172

(57) ABSTRACT

There is provided an image registration device, method, and program capable of performing registration between two images obtained by imaging a subject configured to include parts of a plurality of bones, such as the vertebral column, with high accuracy. The image registration device includes: a medical image acquisition unit that acquires first and second three-dimensional images by imaging a subject configured to include parts of a plurality of bones at different points in time; an identification unit that identifies the parts of the plurality of bones included in each of the first and second three-dimensional images; a matching unit that matches a part of each bone included in the first three-dimensional image with a part of each bone included in the second three-dimensional image; and a registration processing unit that performs registration processing between images of the matched parts of the bones.

### CROSS-REFERENCE TO RELATED APPLICATIONS

The present application claims priority under 35 U.S.C. §119 to Japanese Patent Application No. 2015-191097, filed on Sep. 29, 2015, all of which are hereby expressly incorporated by reference into the present application.

### BACKGROUND OF THE INVENTION

1. Field of the Invention

The present invention relates to an image registration device, method, and non-transitory computer readable recording medium storing a program for performing registration between two images obtained by imaging a subject, which is configured to include parts of a plurality of bones, at different points in time.

2. Description of the Related Art

Various methods of generating a temporal difference image from temporal images captured by two-dimensional simple X-rays or from temporal images captured by three-dimensional computed tomography (CT) have been proposed. By generating such a temporal difference image, it becomes easy to find a lesion with a small contrast or size. In a CT image having a plurality of slices, it is possible to reduce the time and effort taken for registration between temporal images or the time and effort taken going back and forth when observing temporal images.

In particular, in a case where an imaging range, imaging conditions (a slice interval, a reconstruction function, and the like), and the shape of the organ that is a subject are different between temporal images, it takes a very long time to perform manual registration between the temporal images and compare the slices one by one.

As a technique for generating a temporal difference image between medical images, a number of methods that help find a lesion, such as a pulmonary nodule, with the lung field of a chest image as a target have been mainly proposed.

For example, a method of generating a difference image of the lung field of a chest image captured by CT has been proposed in Takayuki Ishida, et al., “3D temporal subtraction on multislice CT images using nonlinear warping technique”, SPIE 6514, Medical Imaging 2007:Computer-Aided Diagnosis, 65143I, 2007. Specifically, a method of performing registration by performing rough registration of the lung between temporal images using a region of interest of the lung field area (global matching) and correcting the deformation of a local lung field using a smaller region of interest (local matching) has been proposed. Then, a difference image is generated by taking the difference between the images registered in this manner.

Thus, in a case where a non-rigid organ, such as the lung field, is a registration target, the entire organ is subjected to non-rigid registration processing for the registration in many cases.

### SUMMARY OF THE INVENTION

However, in a case where the registration target is, for example, a vertebral column, it is difficult to perform registration processing the entire vertebral column by rigid registration processing since each of vertebrae that form the vertebral column is rigid but the entire vertebral column bends or twists at an intervertebral disc (coupling portion between the vertebrae), which is not rigid, when viewed in terms of the entire vertebral column. In addition, in a case where the entire vertebral column is subjected to non-rigid registration processing, there is a problem that distortion occurs in the vertebrae that are rigid.

For the same reason, even if global matching for the entire vertebral column is performed in order to perform rough registration, it is difficult to match all the vertebrae in a case where the bending of the vertebral column is different between temporal images. In order to generate a difference image of the vertebrae, a set of vertebrae need to be correctly registered between temporal images.

JP2014-8414A discloses performing global matching for the entire image and then performing local matching for a selected sub-region, as in Takayuki Ishida, et al., “3D temporal subtraction on multislice CT images using nonlinear warping technique”, SPIE 6514, Medical Imaging 2007:Computer-Aided Diagnosis, 65143I, 2007. However, whichever the non-rigid registration or the rigid registration is performed in the global matching as described above, a problem occurs in each of the registration processes.

In addition, JP2011-224388A discloses specifying vertebrae from a current image, obtaining vertebrae in a past image corresponding to the vertebrae of the current image, calculating the rotational components of the corresponding vertebrae by performing registration of the corresponding vertebrae of the current image and the past image, and evaluating the scoliosis of the vertebral column based on the rotational components of the respective vertebrae.

However, JP2011-224388A has proposed only calculating the rotational components by performing registration of each vertebra, and there is no proposal for the registration of the entire vertebral column.

In view of the aforementioned situation, it is an object of the invention to provide an image registration device, method, and non-transitory computer readable recording medium storing a program capable of performing registration between two images obtained by imaging a subject configured to include parts of a plurality of bones, such as the vertebral column, with high accuracy.

An image registration device of the invention comprises: an image acquisition unit that acquires first and second images by imaging a subject configured to include parts of a plurality of bones at different points in time; an identification unit that identifies the parts of the plurality of bones included in each of the first and second images; a matching unit that matches a part of each bone included in the first image with a part of each bone included in the second image; and a registration processing unit that performs registration processing between images of the matched parts of the bones.

The image registration device of the invention described above can further comprise a difference image generation unit that generates a difference image between the first and second images having been subjected to the registration processing.

In the image registration device of the invention described above, the registration processing unit can extract parts of the bones included in each of the first and second images, perform the registration processing using images of the extracted parts of the bones, and generate a composite image by combining images of the parts of the bones of one of the first and second images, the one of the first and second image is moved and deformed by the registration processing. The difference image generation unit can generate the difference image by calculating a difference between the other one of the first and second images and the composite image.

In the image registration device of the invention described above, the registration processing unit can extract parts of the bones included in one of the first and second images, perform the registration processing using images of the extracted parts of the bones, and generate a composite image by combining images of the parts of the bones after the registration processing. The difference image generation unit can generate the difference image by calculating a difference between the other one of the first and second images and the composite image.

In the image registration device of the invention described above, the registration processing unit can extract parts of the bones included in the first and second images, and perform the registration processing using images of the extracted parts of the bones. The difference image generation unit can generate partial difference images of the respective parts of the bones by calculating a difference between an image of a part of each bone of the first image having been subjected to the registration processing and an image of the part of each bone of the second image corresponding to the part of each bone of the first image, and generate the difference image by combining the generated partial difference images of the respective parts of the bones.

In the image registration device of the invention described above, the registration processing unit can extract parts of the bones included in the first and second images, and perform the registration processing using images of the extracted parts of the bones. The difference image generation unit can generate partial difference images of the respective parts of the bones by calculating a difference between an image of a part of each bone of the first image having been subjected to the registration processing and an image of the part of each bone of the second image corresponding to the part of each bone of the first image, and generate the difference image by combining the generated partial difference images of the respective parts of the bones.

In the image registration device of the invention described above, the registration processing unit can perform at least one of rigid registration processing and non-rigid registration processing as the registration processing.

In the image registration device of the invention described above, the registration processing unit can perform the non-rigid registration processing after performing the rigid registration processing.

In the image registration device of the invention described above, the part of the bone can be a vertebra, and the subject can be a vertebral column.

In the image registration device of the invention described above, the registration processing unit sets at least three landmarks for each part of the bone, and performs the registration processing using the at least three landmarks.

In the image registration device of the invention described above, in a case where the part of the bone is a vertebra and the subject is a vertebral column, the registration processing unit can set, as the landmarks, intersections between a centerline of a vertebral body included in the vertebra and two intervertebral discs adjacent to the vertebra.

In the image registration device of the invention described above, the registration processing unit can set an intersection between a centerline of a spinal cord and a plane, which passes through a midpoint between the two intersections and is perpendicular to a straight line connecting the two intersections to each other, as the landmark.

An image registration method of the invention comprises: acquiring first and second images by imaging a subject configured to include parts of a plurality of bones at different points in time; identifying the parts of the plurality of bones included in each of the first and second images; matching a part of each bone included in the first image with a part of each bone included in the second image; and performing registration processing between images of the matched parts of the bones.

A non-transitory computer readable recording medium storing an image registration program of the invention causes a computer to function as: an image acquisition unit that acquires first and second images by imaging a subject configured to include parts of a plurality of bones at different points in time; an identification unit that identifies the parts of the plurality of bones included in each of the first and second images; a matching unit that matches a part of each bone included in the first image with a part of each bone included in the second image; and a registration processing unit that performs registration processing between images of the matched parts of the bones.

According to the image registration device, method, and non-transitory computer readable recording medium storing a program of the invention, the first and second images are acquired by imaging a subject configured to include parts of a plurality of bones at different points in time, and the parts of the plurality of bones included in each of the first and second images are identified. Then, a part of each bone included in the first image is matched with a part of each bone included in the second image, and registration processing between images of the matched parts of the bones is performed. By performing registration between the images of the parts of the respective bones as described above, it is possible to perform the registration of the entire subject with high accuracy.

### BRIEF DESCRIPTION OF THE DRAWINGS

FIG. 1 is a block diagram showing the schematic configuration of a medical image diagnosis assistance system using an embodiment of an image registration device, method, and program of the invention.

FIG. 2 is a diagram in which vertebral regions, which match each other between a first three-dimensional image and a second three-dimensional image, are connected to each other by arrows.

FIG. 3 is a diagram illustrating a method of setting a landmark for each vertebral region.

FIG. 4 is a diagram illustrating a method of generating an image of each vertebral region and performing registration.

FIG. 5 is a diagram showing an example of a superimposed image.

FIG. 6 is a flowchart illustrating the operation of the medical image diagnosis assistance system using an embodiment of the image registration device, method, and program of the invention.

FIG. 7 is a flowchart illustrating the operation of another embodiment of the image registration device, method, and program of the invention.

FIG. 8 is a diagram illustrating an example of a method of generating a partial difference image.

### DESCRIPTION OF THE PREFERRED EMBODIMENTS

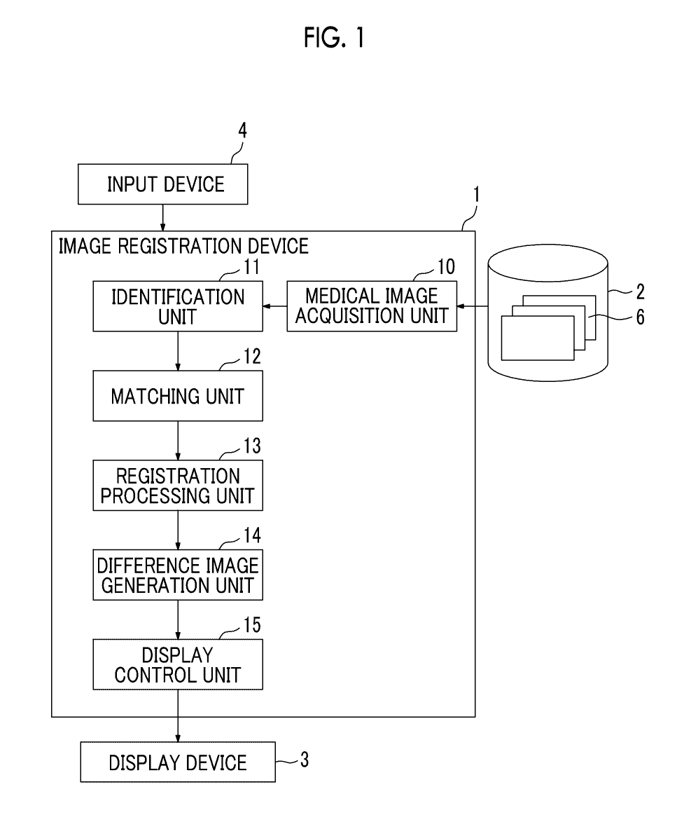

Hereinafter, a medical image diagnosis assistance system using an embodiment of an image registration device, method, and non-transitory computer readable recording medium storing a program of the invention will be described in detail with reference to the diagrams. FIG. 1 is a block diagram showing the schematic configuration of a medical image diagnosis assistance system of the present embodiment.

The medical image diagnosis assistance system of the present embodiment acquires two images by imaging a subject, such as the vertebral column, at different points in time, performs registration between these images, and calculates a difference image by calculating the difference between the two images.

As shown in FIG. 1, the medical image diagnosis assistance system of the present embodiment includes an image registration device 1, a medical image storage server 2, a display device 3, and an input device 4.

The image registration device 1 is formed by installing an image registration program of the present embodiment in a computer.

The image registration device 1 includes a central processing unit (CPU), a semiconductor memory, and a storage device such as a hard disk or a solid state drive (SSD). The image registration program of the present embodiment is installed in the storage device. When the image registration program is executed by the central processing unit, a medical image acquisition unit 10, an identification unit 11, a matching unit 12, a registration processing unit 13, a difference image generation unit 14, and a display control unit 15 shown in FIG. 1 operate.

The image registration program is distributed by being recorded on a recording medium, such as a digital versatile disc (DVD) and a compact disk read only memory (CD-ROM), and is installed into the computer from the recording medium. Alternatively, the image registration program is stored in a storage device of a server computer connected to the network or in a network storage so as to be accessible from the outside, and is downloaded and installed into a computer in response to a request.

The medical image acquisition unit 10 acquires a three-dimensional image 6 that has been captured in advance. The three-dimensional image 6 is obtained by imaging a patient using a CT apparatus or a magnetic resonance imaging (MRI) apparatus, for example. In the present embodiment, two three-dimensional images 6 are acquired by imaging the vertebral column of a patient at different points in time, and a difference image between the two three-dimensional images 6 is generated. As the two three-dimensional images 6 captured at different points in time, the three-dimensional image 6 captured in the past and the current three-dimensional image 6 captured this time may be acquired, or the two three-dimensional images 6 captured in the past may be acquired. In the present embodiment, it is assumed that the past three-dimensional image 6 and the current three-dimensional image 6 are acquired, and the past three-dimensional image 6 is referred to as a first three-dimensional image (corresponding to a first image of the invention) and the current three-dimensional image 6 is referred to as a second three-dimensional image (corresponding to a second image of the invention).

Although the three-dimensional image 6 is acquired by imaging the vertebral column of the patient in the present embodiment, imaging targets (subjects) are not limited to the vertebral column, and any imaging target configured to include parts of a plurality of bones may be imaged. For example, ribs configured to include parts of a plurality of left and right bones, bones of the hand configured to include distal phalanx, middle phalanx, proximal phalanx, and metacarpal, bones of the arm configured to include humerus, ulna, and radius, and bones of the leg configured to include femur, patella, tibia, and fibula may also be imaged.

The part of the bone means a constituent unit of a local bone that forms a subject, such as the vertebral column or ribs. However, the part of the bone does not necessarily need to be a single bone. For example, for a part where deformation due to fracture or the movement of the subject is hard to occur, a set of a plurality of bones may be treated as the part of the bone. That is, the part of the bone may be treated as a constituent unit of one bone forming the subject.

In addition, the part of the bone is not limited to only a region extracted by image processing or the like. For example, a region obtained by extending the extracted region at a rate set in advance may be treated as a region of the part of the bone.

As the three-dimensional image 6, volume data configured to include tomographic images, such as axial tomographic images, sagittal tomographic images, and coronal tomographic images, may be acquired, or a single tomographic image may be acquired.

The three-dimensional image 6 is stored in the medical image storage server 2 in advance together with the identification information of the patient, and the medical image acquisition unit 10 reads the three-dimensional image 6 having the identification information from the medical image storage server 2 based on the identification information of the patient, which has been input by the user using the input device 4 or the like, and temporarily stores the read three-dimensional image 6.

The identification unit 11 performs processing for identifying a plurality of vertebrae that from the vertebral column included in each of the first three-dimensional image and the second three-dimensional image. As the processing for identifying the vertebrae, it is possible to use known methods, such as a method using the morphology operation, a region growing method based on the seed point, and a method disclosed in JP2009-207727A. The identification unit 11 identifies an intervertebral disc region interposed between adjacent vertebral regions. As the processing for identifying an intervertebral disc region, it is possible to use known methods, such as the region growing method described above.

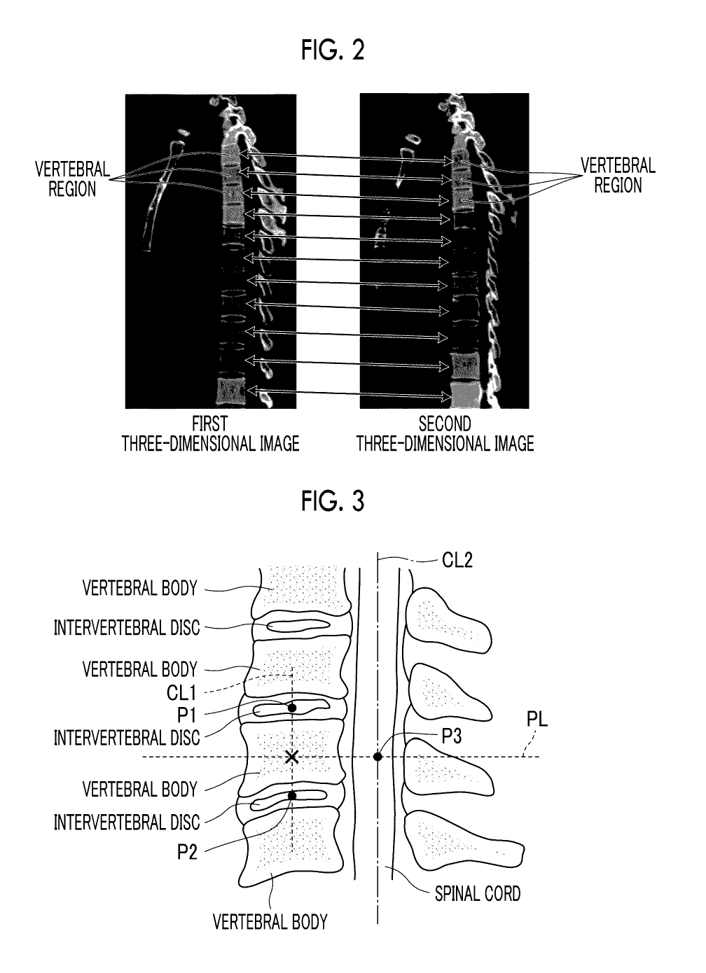

The matching unit 12 matches each vertebral region included in the first three-dimensional image with each vertebral region included in the second three-dimensional image. Specifically, the matching unit 12 calculates a correlation value for a combination of all vertebral regions between the first three-dimensional image and the second three-dimensional image using the pixel value (for example, a CT value) of each vertebral region. Then, in a case where the correlation value is equal to or greater than a threshold value set in advance, the combination of vertebral regions having the correlation value is determined to be a combination for which matching is to be performed. As a method of calculating a correlation value, for example, a correlation value may be calculated using zero-mean normalized cross-correlation (ZNCC). However, other calculation methods may be used without being limited to this. FIG. 2 is a diagram in which vertebral regions, which match each other between the first three-dimensional image and the second three-dimensional image, are connected to each other by arrows.

The registration processing unit 13 performs registration processing on images of the vertebral regions, which match each other as shown in FIG. 2, for each combination of vertebral regions. First, the registration processing unit 13 sets a landmark for each vertebral region included in each of the first and second three-dimensional images. For example, as shown in FIG. 3, intersections P1 and P2 between intervertebral discs present above and below each vertebral region and the centerline CL1 of the vertebral body in the vertebral region are set as landmarks. In addition, an intersection P3 between the centerline CL2 of the spinal cord and a plane PL, which passes through a midpoint (x mark shown in FIG. 3) between the intersections P1 and P2 and is perpendicular to the straight line passing through the intersections P1 and P2, is set as a third landmark.

The centerline CL1 of the vertebral body may be obtained, for example, by connecting the center-of-gravity positions of respective vertebral regions to each other as a curve by spline interpolation.

By setting the landmarks of three points based on the anatomical features as in the present embodiment, it is possible to perform three-dimensional registration with high accuracy. The number of landmarks is not limited to three points, and it is possible to perform more accurate registration by setting four or more points. In the present embodiment, in order to perform three-dimensional registration, landmarks of three points are set. However, for example, in the case of performing two-dimensional registration between tomographic images, only two landmarks may be set.

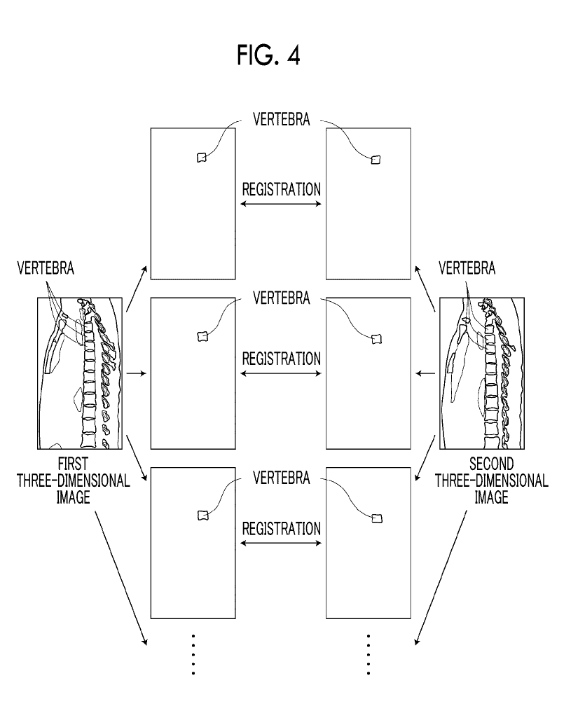

Then, as shown in FIG. 4, for each of the first three-dimensional image and the second three-dimensional image, a three-dimensional image of each vertebral region is generated by extracting each vertebral region and forming one three-dimensional image. Then, registration processing between the images of the respective matched vertebral regions is performed. In the present embodiment, a three-dimensional image of each vertebral region generated from the second three-dimensional image that is a current three-dimensional image is set as a fixed image, and a three-dimensional image of each vertebral region generated from the first three-dimensional image that is a three-dimensional image captured in the past is moved and deformed to perform registration.

First, registration is performed using the landmarks of three points set in each of the three-dimensional image of the vertebral region of the first three-dimensional image and the three-dimensional image of the vertebral region of the second three-dimensional image corresponding to the vertebral region. Specifically, the registration is performed by moving the three-dimensional image of the vertebral region so that the distance between the corresponding landmarks is the shortest.

Then, rigid registration processing is performed based on the three-dimensional image of the vertebral region on which registration processing has been performed by using the three landmarks, and the three-dimensional image of the vertebral region of the second three-dimensional image corresponding to the vertebral region. As the rigid registration processing, for example, it is possible to use processing using an iterative closest point (ICP) method. However, other known methods may be used.

Then, non-rigid registration processing is performed based on the image of the vertebral region on which the rigid registration processing has been performed, and the three-dimensional image of the vertebral region of the second three-dimensional image corresponding to the vertebral region. As the non-rigid registration processing, for example, it is possible to use processing using a free-form deformation (FFD) method or processing using a thin-plate spline (TPS) method. However, other known methods may be used.

That is, three registration processes of the registration processing using the landmarks of three points, the rigid registration processing, and the non-rigid registration processing are performed for the three-dimensional image of the vertebral region generated from the first three-dimensional image and the three-dimensional image of the vertebral region generated from the second three-dimensional image. Although the three registration processes are performed as described above in the present embodiment, only the rigid registration processing and the non-rigid registration processing may be performed. It is possible to perform the registration of the whole subject with high accuracy by performing above described registration processing including matching processing.

In case where producing a difference image, following processing is further processed. Then, the registration processing unit 13 generates a composite image by combining the three-dimensional images of the respective vertebral regions that have been subjected to the three registration processes as described above. Specifically, the composite image is generated by setting an initial value image, which is a three-dimensional image having the same size as the second three-dimensional image and in which all pixel values are zero, and combining the three-dimensional image of each vertebral region of the first three-dimensional image sequentially on the initial value image. The composite image generated by the registration processing unit 13 is output to the difference image generation unit 14.

The difference image generation unit 14 generates a difference image by calculating the difference between the composite image generated by the registration processing unit 13 and the second three-dimensional image set as a fixed image. The difference image generated in this manner is an image that highlights a lesion, such as bone metastasis that is not present in the first three-dimensional image captured in the past but is present in the second three-dimensional image captured this time.

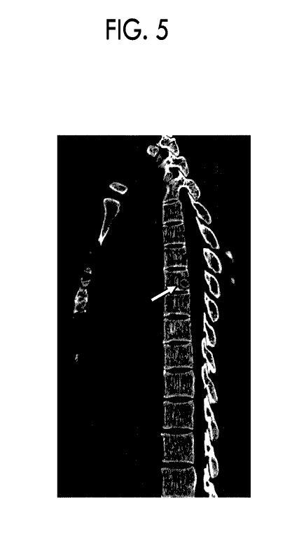

The display control unit 15 generates a superimposed image by superimposing the difference image generated by the difference image generation unit 14 on the second three-dimensional image, and displays the superimposed image on the display device 3. Specifically, the display control unit 15 generates a color image by assigning predetermined colors for the difference image and superimposes the color image on the second three-dimensional image, which is a monochrome image, thereby generating a superimposed image. FIG. 5 is a diagram showing an example of a superimposed image. A portion indicated by an arrow in FIG. 5 is an image of bone metastasis appearing on the difference image.

The display device 3 includes a display device, such as a liquid crystal display, and displays the first and second three-dimensional images and the difference image described above.

The input device 4 receives various setting inputs from the user, and includes an input device, such as a keyboard or a mouse. For example, the input device 4 receives a setting input of the identification information of a patient, a setting input of the landmark described above, and the like.

The display device 3 may also be used as the input device 4 by using a touch panel.

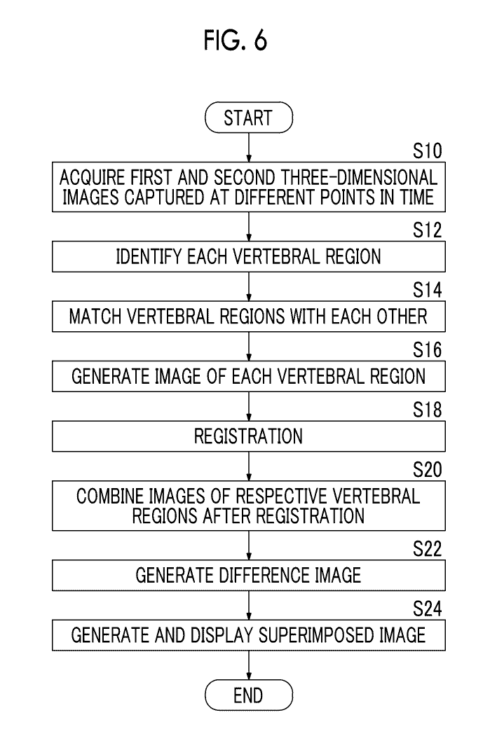

Next, the operation of the medical image diagnosis assistance system of the present embodiment will be described with reference to the flowchart shown in FIG. 6.

First, based on the input of the identification information of a patient from the user, first and second three-dimensional images obtained by imaging the patient at different points in time are acquired by the medical image acquisition unit 10 (S10).

The first and second three-dimensional images acquired by the medical image acquisition unit 10 are input to the identification unit 11. The identification unit 11 identifies each vertebral region included in each of the first and second three-dimensional images (S12).

The information of each vertebral region identified by the identification unit 11 is input to the matching unit 12, and the matching unit 12 matches each vertebral region included in the first three-dimensional image with each vertebral region included in the second three-dimensional image (S14).

Then, a three-dimensional image of each vertebral region is generated by extracting each vertebral region from the first and second three-dimensional images (S16). Then, registration processing between the three-dimensional image of each vertebral region generated from the first three-dimensional image and the three-dimensional image of each vertebral region generated from the second three-dimensional image is performed (S18). Specifically, the registration processing using the landmarks of three points, the rigid registration processing, and the non-rigid registration processing that have been described above are performed as registration processing.

Then, a composite image is generated by combining the three-dimensional images of the respective vertebral regions of the first three-dimensional image having been subjected to the registration processing (S20), and a difference image is generated by calculating the difference between the composite image and the second three-dimensional image (S22).

The display control unit 15 generates a superimposed image by superimposing the difference image on the second three-dimensional image, and displays the generated superimposed image on the display device 3 (S24).

According to the medical image diagnosis assistance system of the embodiment described above, the first and second three-dimensional images are acquired by imaging the vertebral column configured to include a plurality of vertebrae at different points in time, and a plurality of vertebral regions included in each of the first and second three-dimensional images are identified. Then, each vertebral region included in the first three-dimensional image is matched with each vertebral region included in the second three-dimensional image, and registration processing between the three-dimensional images of the matched vertebral regions is performed. By performing registration between the three-dimensional images of the respective vertebral regions in this manner, it is possible to perform the registration of the entire vertebral column with high accuracy.

In the embodiment described above, three-dimensional images of the respective vertebral regions are generated from the first and second three-dimensional images, and registration processing between the three-dimensional images of the respective vertebral regions is performed. However, three-dimensional images of the respective vertebral regions do not necessarily need to be generated from both the three-dimensional images. For example, a three-dimensional image of each vertebral region may be generated only from the first three-dimensional image, and registration processing between the three-dimensional image of each vertebral region generated from the first three-dimensional image and a three-dimensional image of a vertebral region in the second three-dimensional image corresponding to the vertebral region may be performed in a state in which the second three-dimensional image that is a fixed image is maintained as it is. Conversely, a three-dimensional image of each vertebral region may be generated only from the second three-dimensional image, and the first three-dimensional image may be maintained as it is.

In the embodiment described above, a composite image is generated by combining the three-dimensional images of the respective vertebral regions generated from the first three-dimensional image, and a difference image between the composite image and the second three-dimensional image is generated. However, without being limited thereto, registration processing between the three-dimensional image of each vertebral region generated from the first three-dimensional image and the three-dimensional image of each vertebral region generated from the second three-dimensional image may be performed, and then a plurality of partial difference images may be generated by calculating the difference between the three-dimensional image of each vertebral region generated from the first three-dimensional image after the registration processing and the three-dimensional image of each vertebral region generated from the second three-dimensional image. By combining the plurality of partial difference images, a difference image may be generated.

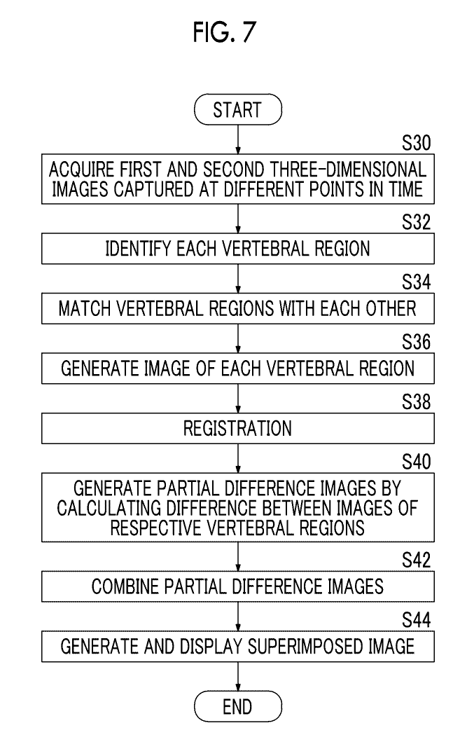

FIG. 7 is a flowchart showing a case of generating a difference image by generating partial difference images as described above and combining the generated partial images.

Processing up to the registration of images of respective vertebral regions of S30 to S38 shown in FIG. 7 is the same as the processing of S10 to S18 shown in FIG. 6 of the embodiment described above.

Then, the difference image generation unit 14 generates partial difference images of the respective vertebral regions by calculating the difference between the three-dimensional image of each vertebral region of the first three-dimensional image having been subjected to the registration processing and the three-dimensional image of each vertebral region of the second three-dimensional image corresponding to the three-dimensional image of the vertebral region (S40), and generates a difference image by combining the generated partial difference images of the respective vertebral regions (S42).

Then, as in the embodiment described above, the display control unit 15 generates a superimposed image by superimposing the difference image on the second three-dimensional image, and displays the generates superimposed image on the display device 3 (S44).

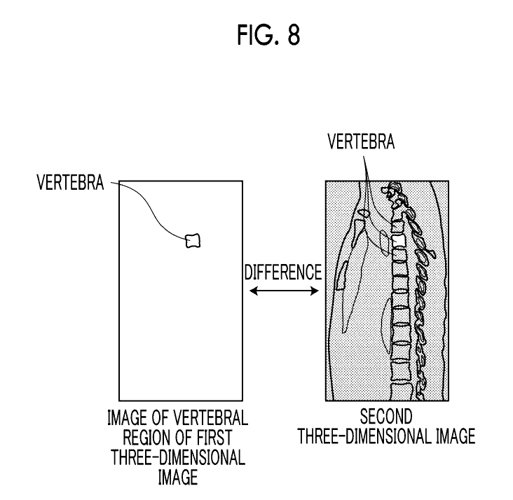

Also in the case of generating a partial difference image as described above, the three-dimensional images of each vertebral region may not be necessarily generated from both the first and second three-dimensional images. For example, the three-dimensional image of each vertebral region may be generated only from the first three-dimensional image, and the second three-dimensional image that is a fixed image may be maintained as it is. When generating a partial difference image, a partial difference image may be generated by masking a region other than a vertebral region to be subtracted in the second three-dimensional image (portion shown in gray in FIG. 8) and calculating the difference between the second three-dimensional image after the mask processing and the three-dimensional image of the vertebral region of the first three-dimensional image as shown in FIG. 8. Conversely, a three-dimensional image of each vertebral region may be generated only from the second three-dimensional image, and a partial difference image may be generated in the same manner as described above in a state in which the first three-dimensional image is maintained as it is.

In the embodiment described above, the three-dimensional image 6 is acquired by imaging the vertebral column of the patient. However, as described above, imaging targets (subjects) are not limited to the vertebral column, and any imaging target configured to include parts of a plurality of bones may be imaged. Ribs, bones of the hand, bones of the arm, bones of the leg, and the like may also be imaged. For example, in the case of ribs, first to twelfth ribs are included, and it is preferable to generate a difference image by identifying the first to twelfth ribs in the first and second three-dimensional images, performing registration processing for each of the corresponding first to twelfth ribs between the first and second three-dimensional images, and then calculating the difference between the three-dimensional images of each rib region.

In the case of the bones of the hand, it is preferable to generate a difference image by identifying distal phalanx, middle phalanx, proximal phalanx, and metacarpal in the first and second three-dimensional images, performing registration processing for each of the parts of the corresponding bones between the first and second three-dimensional images, and then calculating the difference between the three-dimensional images of each of the parts of the bones.

In the case of the bones of the arm, it is preferable to generate a difference image by identifying humerus, ulna, and radius in the first and second three-dimensional images, performing registration processing for each of the parts of the corresponding bones between the first and second three-dimensional images, and then calculating the difference between the three-dimensional images of each of the parts of the bones.

In the case of the bones of the leg, it is preferable to generate a difference image by identifying femur, patella, tibia, and fibula in the first and second three-dimensional images, performing registration processing for each of the parts of the corresponding bones between the first and second three-dimensional images, and then calculating the difference between the three-dimensional images of each of the parts of the bones.

For the identification of a part of each bone in a subject, such as the ribs or bones of the hand described above, known methods, for example, a region growing method may be used.

What is claimed is:

1. An image registration device, comprising:
an image acquisition unit that acquires first and second images by imaging a subject configured to include parts of a plurality of bones at different points in time;
an identification unit that identifies the parts of the plurality of bones included in each of the first and second images;
a matching unit that matches a part of each bone included in the first image with a part of each bone included in the second image; and
a registration processing unit that performs registration processing between images of the matched parts of the bones.

2. The image registration device according to claim 1, further comprising:
a difference image generation unit that generates a difference image between the first and second images having been subjected to the registration processing.

3. The image registration device according to claim 2,
wherein the registration processing unit extracts parts of the bones included in each of the first and second images, performs the registration processing using images of the extracted parts of the bones, and generates a composite image by combining images of the parts of the bones of one of the first and second images, the one of the first and second images are moved and deformed by the registration processing, and
the difference image generation unit generates the difference image by calculating a difference between the other one of the first and second images and the composite image.

4. The image registration device according to claim 2,
wherein the registration processing unit extracts parts of the bones included in one of the first and second images, performs the registration processing using images of the extracted parts of the bones and images of the other one of the first and second images, and generates a composite image by combining images of the parts of the moved and deformed bones by the registration processing, and
the difference image generation unit generates the difference image by calculating a difference between the other one of the first and second images and the composite image.

5. The image registration device according to claim 2,
wherein the registration processing unit extracts parts of the bones included in the first and second images, and performs the registration processing using images of the extracted parts of the bones, and
the difference image generation unit generates partial difference images of the respective parts of the bones by calculating a difference between an image of a part of each bone of the first image having been subjected to the registration processing and an image of the part of each bone of the second image corresponding to the part of each bone of the first image, and generates the difference image by combining the generated partial difference images of the respective parts of the bones.

6. The image registration device according to claim 2,
wherein the registration processing unit extracts parts of the bones included in one of the first and second images, and performs the registration processing using images of the extracted parts of the bones, and
the difference image generation unit generates partial difference images of the respective parts of the bones by calculating a difference between an image of a part of each bone having been subjected to the registration processing and the other one of the first and second images corresponding to the part of each bone, and generates the difference image by combining the generated partial difference images of the respective parts of the bones.

7. The image registration device according to claim 1,
wherein the registration processing unit performs at least one of rigid registration processing and non-rigid registration processing as the registration processing.

8. The image registration device according to claim 2,
wherein the registration processing unit performs at least one of rigid registration processing and non-rigid registration processing as the registration processing.

9. The image registration device according to claim 3,
wherein the registration processing unit performs at least one of rigid registration processing and non-rigid registration processing as the registration processing.

10. The image registration device according to claim 7,
wherein the registration processing unit performs the non-rigid registration processing after performing the rigid registration processing.

11. The image registration device according to claim 8,
wherein the registration processing unit performs the non-rigid registration processing after performing the rigid registration processing.

12. The image registration device according to claim 9,
wherein the registration processing unit performs the non-rigid registration processing after performing the rigid registration processing.

13. The image registration device according to claim 1,
wherein the part of the bone is a vertebra, and the subject is a vertebral column.

14. The image registration device according to claim 2,
wherein the part of the bone is a vertebra, and the subject is a vertebral column.

15. The image registration device according to claim 3,
wherein the part of the bone is a vertebra, and the subject is a vertebral column.

16. The image registration device according to claim 1,
wherein the registration processing unit sets at least three landmarks for each part of the bone, and performs the registration processing using the at least three landmarks.

17. The image registration device according to claim 16,
wherein, in a case where the part of the bone is a vertebra and the subject is a vertebral column, the registration processing unit sets, as the landmarks, intersections between a centerline of a vertebral body included in the vertebra and two intervertebral discs adjacent to the vertebra.

18. The image registration device according to claim 17,
wherein the registration processing unit sets an intersection between a centerline of a spinal cord and a plane, which passes through a midpoint between the two intersections and is perpendicular to a straight line connecting the two intersections to each other, as the landmark.

19. An image registration method using the image registration device according to claim 1, comprising:
acquiring first and second images by imaging a subject configured to include parts of a plurality of bones at different points in time;
identifying the parts of the plurality of bones included in each of the first and second images;
matching a part of each bone included in the first image with a part of each bone included in the second image; and
performing registration processing between images of the matched parts of the bones.

20. A non-transitory computer readable recording medium storing an image registration program causing the image registration device according to claim 1 as a computer to function as:
an image acquisition unit that acquires first and second images by imaging a subject configured to include parts of a plurality of bones at different points in time;
an identification unit that identifies the parts of the plurality of bones included in each of the first and second images;
a matching unit that matches a part of each bone included in the first image with a part of each bone included in the second image; and
a registration processing unit that performs registration processing between images of the matched parts of the bones.
